(19) United States
(12) Patent Application Publication
(10) Pub. No.: US 2019/0293213 A1
(43) Pub. Date: Sep. 26, 2019

(54) PIPE COUPLER HAVING AN INTEGRAL MOUNTING FLANGE

(71) Applicant: Albert Swietlik, Nantucket, MA (US)

(72) Inventor: Albert Swietlik, Nantucket, MA (US)

(21) Appl. No.: 15/926,297

(22) Filed: Mar. 20, 2018

(51) Int. Cl. F16L 15/08

(52) U.S. Cl. CPC F16L 15/08

(57) ABSTRACT

A pipe coupler includes first and second coupler end portions, each configured for attachment to a pipe or pipe fitting, a coupler central portion extending between the coupler end portions, and a mounting flange. The mounting flange, the first and second coupler end portions and the coupler central portion are an integral, one-piece continuous member. The mounting flange extends outward from either from the coupler central portion or one of the coupler end portions and has holes therethrough to facilitate mounting to a mounting surface.

### STATEMENT REGARDING FEDERALLY SPONSORED RESEARCH OR DEVELOPMENT

Not Applicable

### BACKGROUND OF THE INVENTION

The present invention relates to piping and pipefitting and more specifically to a pipe coupler having an integral mounting flange.

Pipe fitting involves the installation and repair of pipes and tubing systems that convey liquid, gas, and occasionally solid materials. This work involves selecting and preparing the pipes or tubing, and joining pipe sections to one another or to other apparatus by various means. Different countries have different standards and requirements for piping and thread sizes used in pipe fitting.

Steel pipe or black iron pipe was once the most popular choice for supply of water and flammable gases. Steel pipe is sometimes joined using threaded connections in which tapered threads are cut into male and female ends of a pipe and fitting to be joined. A sealant is applied in the form of a thread sealing compound or thread seal tape (also known as PTFE or Teflon tape) and the pipe is then threaded into a cooperative threaded fitting. Many piping applications that at one time used steel piping now utilize plastic piping which is not subject to corrosion and is less expensive and lighter than steel piping. Nevertheless, threaded steel pipe is still widely used in buildings to convey natural gas or propane fuel and is a popular choice in fire sprinkler systems due to its resistance to mechanical damage and high heat.

Assembling threaded steel pipe takes skill and planning to allow lengths of pipe to be screwed together in sequence. Most threaded-pipe systems require the use of a strategically located pipe-union fitting during final assembly. Threaded steel pipe is heavy and must be supported via attachment to a support surface. Hangers are often employed for this purpose. When piping through a wall, floor or ceiling, etc. (hereinafter “wall”) a hole is provided therethrough for passage of the pipe and a pipe is passed through the opening and connected to a cooperative fitting. In the absence of suitable support for the pipe during the installation process, piping in this manner can be awkward.

Pipe couplings are well known in the art and are available in different lengths. The term coupling is generally used to refer to a fitting employed to couple one pipe or fitting to another pipe or fitting. Typically, pipe couplings are devoid of any mechanism for attachment to a support surface. Moreover, piping threads and sizes vary and are subject to different standards. One well known standard is known as National pipe threads (NPT) standard, and another as the British Standard Piping (BSP) standard. If the two ends of a coupling are different (e.g. one is BSP threaded and one is NPT threaded or the nature of the attachment to pipes at opposite ends of the coupling are different) the coupler is frequently referred to as an adapter. When the two ends use the same connection method but are of a different size, the fitting is referred to as a reducing coupling or a reducer.

While the above description pertains generally to threaded fittings, copper tubing and plastic piping employ couplings that, depending upon the application, may have either threaded or non-threaded end connections. When connecting copper tubing to unthreaded couplings, the connection is typically soldered. When connecting plastic piping to couplings, connection is typically made via solvent attachment.

It would be desirable for pipefitters to have a fitting that simplified piping from one side of a wall to the other side of the wall and which facilitated piping from either side while supporting pipes coupled thereto.

### SUMMARY OF THE INVENTION

An improved pipe coupler includes first and second coupler end portions that are configured for attachment to first and second pipe members, a coupler central portion that extends between the first and second coupler end portions and a mounting flange that extends radially outward from the coupler central portion or from one of the coupler end portions. The mounting flange includes holes therethrough to facilitate secure mounting of the mounting flange and the coupler to a mounting surface. The coupler end portions, the coupler central portion and the mounting flange are an integral, one-piece, continuous member typically formed by casting or molding.

The coupler end portions may each be configured for attachment to an end of a pipe member that is sized and configured for mating therewith. By way of example, coupler end portions may be female threaded coupler end portions, male threaded coupler end portions or may have a female threaded coupler end portion at one end of the pipe coupler and a male threaded coupler end portion at the other end of the pipe coupler. Alternatively, the first and second coupler end portions may be female end portions having a generally smooth unthreaded cylindrical interior surface sized and configured to mateably receive male end portions of first and second pipe members having a smooth cylindrical outer surface such as employed with copper tubing and plastic piping. Additionally, the first and second coupler end portions may have male end portions having a generally smooth unthreaded cylindrical outer surface sized to be mateably inserted in female end portions of first and second pipe or tubing members having a generally smooth unthreaded cylindrical inner surface. In another embodiment, one of the unthreaded coupler end portions of the pipe coupler is a female coupler end portion and the other coupler end portion of the pipe coupler is an unthreaded male coupler end portion and the end portions are adapted for connection to an unthreaded male end portion and an unthreaded female end portion of respective first and second pipe members. In other embodiments, the pipe coupler employs other end portion configurations as known in the art for connection to cooperative pipe members.

### BRIEF DESCRIPTION OF THE DRAWINGS

Various aspects of the present invention are discussed below with reference to the accompanying figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, not every component may be labeled in every drawing. The invention will be more fully understood by reference to the Detailed Description of the Invention in conjunction with the following drawings of which:

FIG. 1 is a perspective view of one embodiment of a pipe coupler having an integral mounting flange in accordance with the present invention;

FIG. 2 is a side-cutaway view of the pipe coupler of FIG. 1 with adjacent pipe members configured for threaded attachment to the pipe coupling;

FIG. 3 is an end view of the pipe coupler of FIG. 1;

FIG. 4 is a side-cutaway view of another embodiment of a pipe coupler including an integral mounting flange in accordance with the present invention having non-threaded end portions configured for attachment to non-threaded pipe members;

FIG. 5 is a side-cutaway view of another embodiment of a pipe coupler including an integral mounting flange in which the central coupler portion is provided as an elbow; and

FIG. 6 is a partial side-cutaway view of one end of a pipe coupler in accordance with the present invention in which the mounting flange extends circumferentially outward from the coupler end portion.

### DETAILED DESCRIPTION OF THE INVENTION

In the following description, numerous specific details are set forth in order to provide a thorough understanding of the embodiments of the present invention. It will be understood by those of ordinary skill in the art that these embodiments of the present invention may be practiced without some of these specific details. In other instances, well-known methods, procedures, components and structures may not have been described in detail so as not to obscure the respective embodiments.

The invention is not limited in its application to the details of construction and the arrangement of the components set forth in the following description or illustrated in the drawings. The invention is capable of other embodiments or of being practiced or carried out in various ways. Also, the phraseology and terminology employed herein are for the purpose of description and should not be regarded as limiting.

It is appreciated that certain features of the invention, which are, for clarity, described in the context of separate embodiments, may also be provided in combination in a single embodiment. Additionally, specific features and structures described in conjunction with one embodiment and providing a specific function may be employed in other embodiments provided that such a configuration is consistent with the provision of the specific function or feature in the other embodiments. Conversely, various features of the invention, which are, for brevity, described in the context of a single embodiment, may also be provided separately or in any suitable sub-combination.

A pipe coupler in accordance with the present invention includes an integral mounting flange that extends circumferentially and radially from the pipe coupler in a plane perpendicular a longitudinal axis through the pipe coupler to permit mounting of the pipe coupler to a mounting surface. Once the pipe coupler is securely mounted to the mounting surface with at least a portion of the pipe coupler extending at least partially through an opening in the wall, the pipe fitter may connect pipe members thereto. As used herein, the term “pipe member” is intended to refer to a pipe or a pipe fitting, e.g. as a coupler, adapter, reducer, depending upon the application and configuration of the pipe coupler. Connecting pipe members to a pipe coupler firmly mounted to the wall substantially eases the pipefitting process.

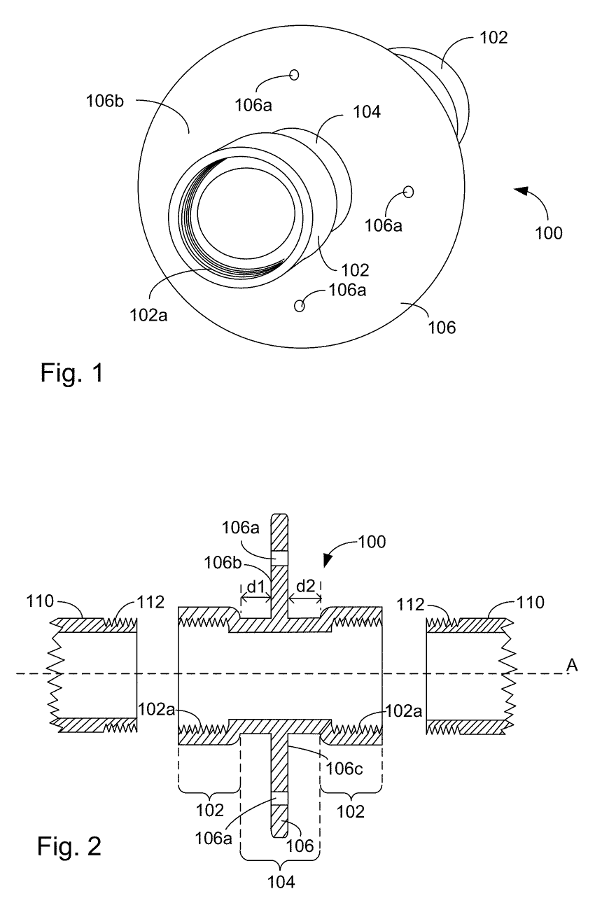

FIGS. 1-3 depict a first embodiment of a pipe coupler 100 having an integral mounting flange. The pipe coupler 100 includes first and second generally cylindrical coupler end portions 102 connected by a generally cylindrical coupler central portion 104. In the illustrated embodiment, the coupler end portions 102 are female threaded coupler end portions 102 having threads 102a on the interior thereof. The threads 102a of the coupler end portions 102 are sized and configured to mate with male threads 112 of pipe members 110 via threaded engagement of respective male threads 112 with the female threads 102a of the coupler end portions 102. The threads 102a on opposing ends of the coupler 100 may be of the same size and configuration or alternatively may be configured to accommodate different pipe threads, and/or sizes of pipes at respective ends to provide a coupler that serves as an adapter and/or a reducer.

The pipe coupler 100 includes a mounting flange 106 having opposing faces 106b, 106c for mounting the pipe coupler 100 to a mounting surface such as the surface of a wall. As illustrated, the mounting flange 106 extends circumferentially and radially outward from the coupler central portion 104 and is formed as an integral, one-piece, continuous member with the coupler central portion 104 and the coupler end portions 102 as a cast or molded article. The mounting flange 106 includes a plurality of holes 106a extending therethrough to facilitate attachment of the mounting flange 106 to a mounting surface. A hole having a diameter larger than the diameter of the coupler end portions 102 is provided in the wall. One end of the pipe coupler 100 is inserted into the hole in the wall with one of the mounting flange faces 106b, 106c in confronting relation with the wall surface. The mounting flange 106 is oriented perpendicularly with respect to a longitudinal axis A through the pipe coupler 100, i.e. the longitudinal axis through the first and second coupler end portions 102 and the coupler central portion 104. The mounting flange 106 may be secured to the mounting surface via the use of screws, bolts, nails or any other suitable fasteners. By securely affixing the coupling 100 to the wall prior to connection of pipe members 110 thereto, pipefitting is substantially eased since connection of adjacent pipe members is being made to a pipe coupling that is securely mounted and which supports connected pipe members once connected thereto. Additionally, once the pipe coupling 100 is affixed to the wall, pipefitting may be performed from either side of the wall which also simplifies the pipe fitting process.

In the embodiment depicted in FIGS. 1-3, the mounting flange 106 extends outward from the coupler central portion 104. Mounting flange face 106b is spaced a distance d1 from one coupler end portion 102 and mounting flange face 106c is spaced a distance d2 from the other end portion 102. The distances d1 and d2 may be equal or alternatively, one of the distances may be greater than the other distance, for example, to accommodate the thickness of a wall or any other desired span.

The pipe coupler 100 may be fabricated of black iron or steel, copper, brass, bronze or any other suitable alloy or metal. Alternatively, the pipe coupler 100 may be fabricated of a plastic, e.g. polyvinyl chloride (PVC) or any other suitable material.

Although the coupler end portions 102 are illustrated as female threaded coupler end portions, the coupler end portions 102 may be provided as male threaded end portions or alternatively, one of the coupler end portions 102 may be provided as a female threaded coupler end portion and the other coupler end portion may be provided as a male threaded end portion. Furthermore, one of the coupler end portions may be provided as a coupler end portion with right handed threads and the other end portion may be provided with left handed threads to facilitate pipe installations in certain situations. Moreover, the coupler end portions 102 may be provided with any other end portion configuration known in the art adapted for connection to a pipe member having an end configuration configured for mating therewith.

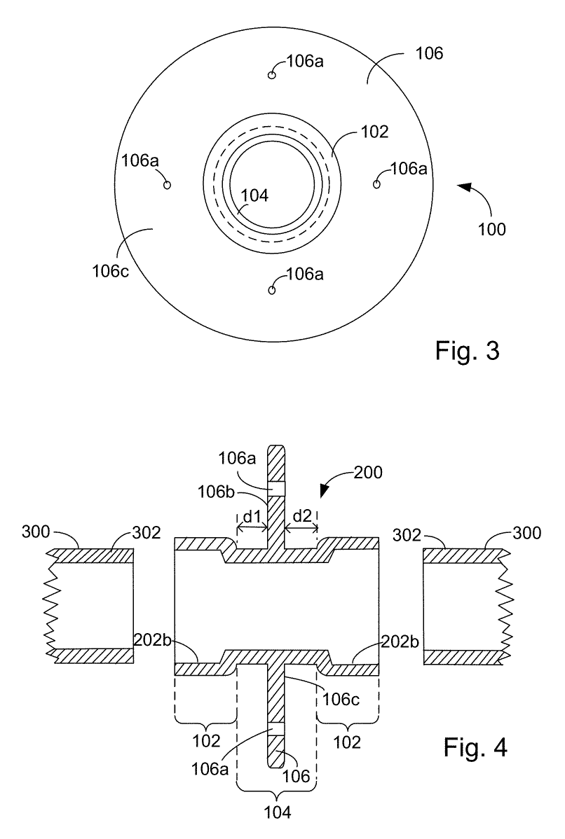

FIG. 4 depicts a pipe coupler 200 that is substantially as described above with respect to FIGS. 1-3, noting however that the coupler end portions 102 are configured as non-threaded female coupler end portions having a generally cylindrical smooth interior surface 202b such as commonly employed with plastic piping and copper tubing. The female non-threaded end portions 102 depicted in FIG. 3 are sized to mateably receive male end portions 302 of pipe members 300. The male end portions 102 have a smooth generally cylindrical outer surface. As discussed above with respect to FIGS. 1-3, both coupler end portions 102 may be provided as female non-threaded end portions as shown or alternatively, as male non-threaded end portions. Alternatively, one coupler end portion may be configured as a female non-threaded end portion and the other coupler end portion may be provided as a male non-threaded end portion. Additionally, the coupler end portions, be they female non-threaded end portions or male non-threaded end portions, may be configured for connection to different diameter pipes or fittings to provide a pipe coupler that serves as a reducer. Also, as discussed above with respect to FIGS. 1-3, the distances d1 and d2 may be same or alternatively, may be different to provide a pipe coupler having a length (d2) of the coupler central portion on one side of the mounting flange 106 to accommodate a given wall thickness or span. When pipe couplers of the type illustrated in FIG. 4 and discussed herein are fabricated of plastic, pipe members are typically connected the pipe coupler end portions via solvent attachment. When pipe couplers of the type illustrated in FIG. 4 and discussed herein are fabricated of copper, another metal or an alloy, pipe members are typically connected to the pipe coupler via the use of solder.

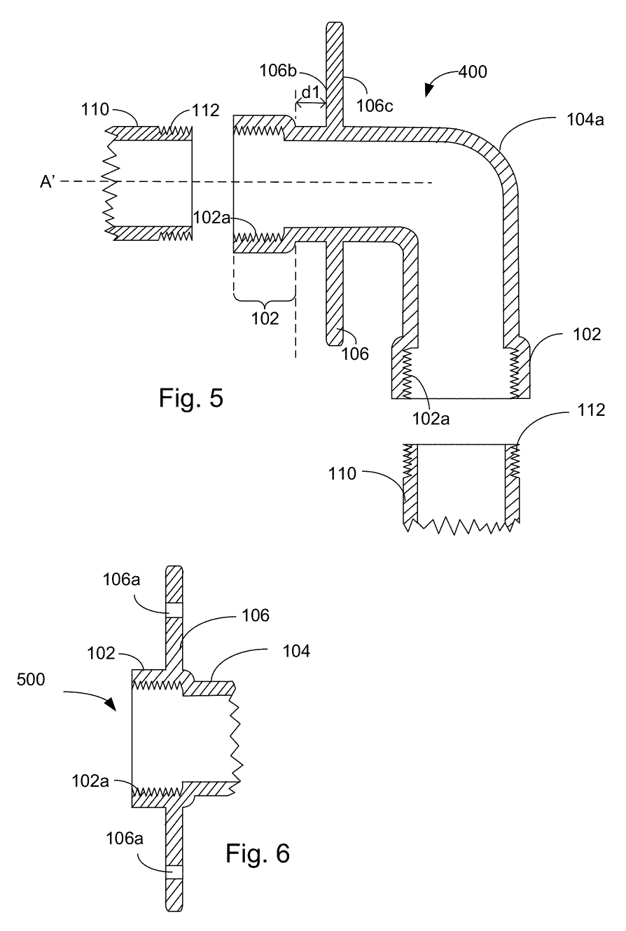

FIG. 5 is a side-cutaway view of a pipe coupler 400 in accordance with the present invention having a mounting flange 106 that is formed as an integral, one-piece, continuous member with coupler end portions 102 and a coupler central portion 104a noting that the coupler central portion 104a is formed as an elbow for joining of pipe members having longitudinal axes at an angle with respect to each other. The mounting flange 106 is oriented generally perpendicularly with respect to a longitudinal axis A′ through the coupler end portion 102 adjacent the mounting flange 106. Though the coupler central portion 104a is depicted as a 90 degree elbow in FIG. 5, the coupler central portion 104a may be provided as a 45 degree elbow or an elbow having any other desired angle. Moreover, the variations in the size and configuration of the coupler end portions 102 and thread configurations discussed in connection with FIGS. 1-3 and non-threaded configurations of coupler end portions discussed with respect to FIG. 4 may be employed in the embodiment depicted in FIG. 5 having a coupler central portion 104a in the form of an elbow.

FIG. 6 illustrates a partial side-cutaway view of an end of a pipe coupler 500 including one coupler end portion 102 and the coupler central portion 104 noting that the mounting flange 106 extends outward from coupler end portion 102 rather than the coupler central portion 104, 104a as depicted in FIGS. 1-5. In one embodiment the mounting flange 106 is located at the distal end of the end coupler end portion 102 so that the mounting flange only protrudes from the wall by the thickness of the mounting flange 106 when mounted thereto. Any of the previously depicted embodiments may be formed with the mounting flange 106 extending outward from the coupler end portion 102 rather than the coupler central portion 104 or 104a. In such embodiments, the length of the coupler central portion 104, 104a may have any desired length to accommodate a specific wall thickness or a desired span.

While the mounting flange is illustrated as being generally circular in the above-described embodiments, the mounting flange may have other shapes. By way of example, the mounting flange may be generally rectangular, generally triangular or any other suitable shape. Moreover, the mounting flange may be provided in the form of a plurality of finger-like projections extending from the coupler. In each case, holes through the mounting flange or finger-like projections are provided to facilitate the mounting of the coupler to a wall.

It will be readily appreciated by those of ordinary skill in the art that alterations, modifications and improvements to the above-described coupling having an integral mounting flange and methods of using the same may be made without departing from the inventive concepts disclosed herein. Such alterations, modifications and improvements are intended to be part of this disclosure and are within the scope of the invention and the foregoing description and drawings are provides as examples of the disclosed coupler. Accordingly, the invention should not be viewed as limited except by the scope and spirit of the appended claims.

What is claimed is:

1. A pipe coupler for fluidically coupling a first pipe member having a first end to a second pipe member having a first end, the pipe coupler comprising:
a first coupler end portion and a second coupler end portion, the first coupler end portion being sized and configured for mating and attachment to the first end of the first pipe member and the second coupler end portion being sized and configured for mating and attachment to the first end of the second pipe member;
a coupler central portion extending between the first coupler end portion and the second coupler end portions to provide a fluidic path through the first coupler end portion, the coupler central portion and the second coupler end portion; and
a mounting flange extending outward from the coupler and generally perpendicularly with respect to a longitudinal axis of at least one of the first and second coupler end portions, the mounting flange having a plurality of holes extending therethrough,
wherein the first and second coupler end portions, the coupler central portion and the mounting flange are an integral, one-piece continuous member.

2. The pipe coupler of claim 1 wherein the first coupler end portion and the second coupler end portions are female threaded end portions.

3. The pipe coupler of claim 1 wherein the first coupler end portion and the second coupler end portions are male threaded end portions.

4. The pipe coupler of claim 1 wherein the first coupler end portion is a female threaded end portion and the second coupler end portion is a male threaded end portion.

5. The pipe coupler of claim 1 wherein first coupler end portion and the second coupler end portion are sized and configured for threaded attachment to the first pipe member and the second pipe member respectively wherein the first coupler end portion and the second coupler end portions have differently sized thread configurations to permit threaded attachment of the first pipe member to the first coupler end portion and the second pipe member to the second coupler end portion where the first and second pipe members have different diameters.

6. The pipe coupler of claim 1 wherein the first pipe member and the second pipe member have first and second different thread configurations, respectively, and the first coupler end portion and the second coupler end portion have different thread configurations corresponding to respective first and second different thread configurations to permit threaded attachment of the first pipe member to the first coupler end portion and threaded attachment of the second pipe member to the second coupler end portion.

7. The pipe coupler of claim 1 wherein the first coupler end portion has a right threaded configuration and the second coupler end portion has a left threaded configuration.

8. The pipe coupler of claim 1 wherein the pipe coupler is made of black iron, steel, brass, bronze, copper or plastic.

9. The pipe coupler of claim 1 wherein the pipe coupler is polyvinyl chloride (PVC).

10. The pipe coupler of claim 1 wherein the first end portion and the second end portion each have a generally smooth cylindrical unthreaded interior surface sized for attachment to unthreaded outer end surfaces of the first pipe member and the second pipe member respectively.

11. The pipe coupler of claim 1 wherein:
the first end of the first pipe member is a male end having a generally cylindrical smooth unthreaded outer surface and the first end of the second pipe member is a female end having a generally cylindrical smooth unthreaded interior surface;
the first coupler end portion of the pipe coupler is a female coupler end portion having a generally smooth cylindrical unthreaded interior surface sized for attachment to the first end of the first pipe member, and
the second coupler end portion of the pipe coupler is a male coupler end portion having a generally smooth cylindrical unthreaded outer surface sized for attachment to the first end of the second pipe member.

12. The pipe coupler of claim 1 wherein the mounting flange extends radially outward from the coupler central portion.

13. The pipe coupler of claim 1 wherein the mounting flange is closer to the first coupler end portion than to the second coupler end portion.

14. The pipe coupler of claim 1 wherein the mounting flange extends radially outward from one of the first and second coupler end portions.

15. The pipe coupling of claim 10 wherein the coupler central portion is formed as an elbow.
